(19) United States
(12) Patent Application Publication
(10) Pub. No.: US 2015/0225113 A1
(43) Pub. Date: Aug. 13, 2015

(54) Hybrid Noise-Insulating Structures and Applications Thereof

(71) Applicant: Cornelius Lungu, (US)

(72) Inventors: Cornelius Lungu, Buhlertal (DE); Alexandru Fenichiu, Buhlertal (DE)

(21) Appl. No.: 14/428,760

(22) PCT Filed: Sep. 17, 2013
(86) PCT No.: PCT/IB2013/058598

§ 371 Date: Mar. 17, 2015

(30) Foreign Application Priority Data
Sep. 18, 2012 (DE) 102012018368.2

(51) Int. Cl. B65D 6/02; F04D 29/66; G10K 11/00; B65D 25/28; B65D 43/16

(52) U.S. Cl. CPC B65D 7/06; B65D 25/28; B65D 43/16; G10K 11/002; F04D 29/664; F04D 29/666

(57) ABSTRACT

The invention relates to structures that are made of hard materials, similar to a skeleton, which are embedded in softer materials (e.g., elastomer). Not only can the sound transmission be greatly limited thereby, but also other functional advantages can be achieved thereby, such as the reduction of the number of parts, because formations can be produced from the embedding material, such as seals, cable passages, membranes, and elastic suspension elements, etc. A special variant of said structures is the light anti-humming layer having a thickness of approx. 1 mm, which greatly reduces humming noises, for example when adhesively bonded to a car door.

This invention relates to hybrid structures (structures with a supporting skeleton, henceforth called embedded grid 1) which is surrounded by viscoelastic materials. These hybrid structures can be used to suppress a noise generation and lead to simplifications and savings due to less parts of a device.

### EXAMPLES

A device (engine, blower, etc.), which produces the noise is mounted in a housing which consists of a support grid, which is embedded in a soft filling stuff.

A transport box, which consists of this embedded support grid 1, will dampen vibration and noise that might arise during transportation.

The drumming of thin enclosures, such as sheet metal housings is prevented by plating them with a thin self-adhesive structure which is applied on their surfaces, this plating structure consisting of this support grid (here, for example, wire mesh) which is embedded in an adhesive stuff.

partition walls, cabinets or curtains from these hybrid structures will also reduce considerably both the passing through and the reflection of the sound.

The advantage of these hybrid structures is that their constitution of at least two materials with very different properties reduce by themselves own resonances, reflects poorly the sound by the soft surface and suppresses the passage of the incident sound to a high degree.

### STATE OF THE ART

The sound deadening is an ongoing task in the world of technology. It is known, for example, how to use various concoctions of sound-absorbing plastics (eg. brand names such as Terophon or Terodem, of the Teroson company) or how to build sandwich structures made of sheet metal with a soft viscoelastic interlayer to abate the sound, see DE10144680A1.

In order to avoid body-sound transmission through solid parts, one can set up or hang up rigid equipments and housing on rubber buffers. You can suppress noise also by sheeting housings with sound-blocking materials. To be effective, such materials are usually thick. Usually you combine several of these measures.

### OBJECT OF THIS INVENTION

To show how it is possible to construct noise-blocking hybrid structures with embedded support grid 1 and housings as thin as possible, which results not only in an efficient noise reduction. These devices may also fulfill other functions in the way that the number of parts and thus the costs are reduced.

Another object of the invention is to teach how to manufacture thin, noise-canceling adhesive tapes (called anti-drumming foils 7), which are applied as a constraining layer on vibrant panels and thereby to form a sandwich structure, which leads to a noise suppression.

### THE SOLUTION

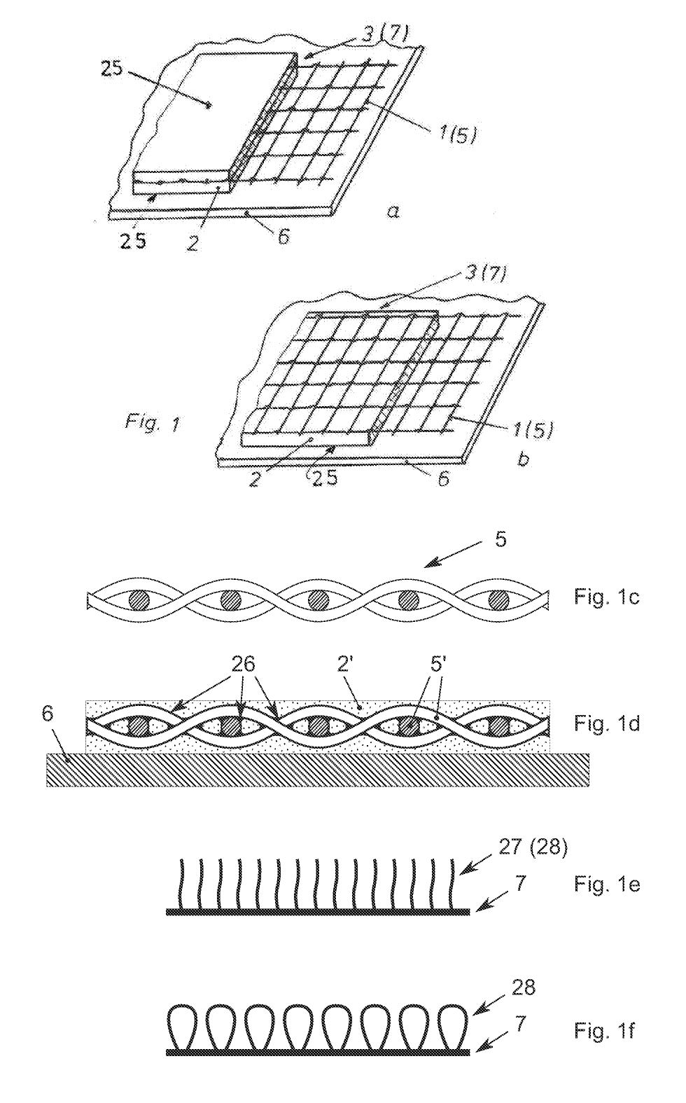

Rigid support grids 1 will be used, from a mechanically highly resilient material, preferably metal and which are embedded in a viscoelastic sound absorbing embedding stuff 2, which can have a variety of compositions. The combination of support grid 1 and the embedding stuff 2 is called a hybrid structure 3. FIG. 1 shows simple examples of the hybrid structure 3 with the support grid 1 (here wire netting 5) which is half or completely embedded in the embedding stuff 2.

FIG. 2 shows a variant with rib mesh 4 which is curved as a support grid 1, wherein the cross-section of the embedding stuff 2 is smooth one side and dome structured on the other side. The embedding stuff 2, which suppresses efficiently the noise, would alone not have enough mechanical strength. Therefore, they can not be used alone for the construction of housings. Hence, the support grid 1 is needed. The rigid support grid 1 acts as a skeleton for a housing. The structure of the steel-reinforced rubber tires, wherein the reinforcement is provided there for other reasons, is somewhat similar to the hybrid structure 3 according to this invention.

In order to implement the invention you would have as the usual case to redesign the housings which contain noise sources. A task for this new design is to reduce the number of the existing parts. A housing 8, which was previously made of plastic or metal, which would be provided with a plurality of rubber parts, will now be built as a single piece of rubber with corresponding protrusions, which is reinforced with the support grid 1. The completion with the embedding stuff 2 is usually done by shaping in a mould.

The Support Grid 1.

The “skeleton” of the housing 8 is composed of one or more support grids. 1. The support grids can be made of perforated sheet metal, possibly deep drawn, rib mesh 4, wire netting 5, hard plastics, braids or hard fibers. The input of the appropriate words, for example, “rib mesh” in the image search on www.google.de shows a wider range of such materials.

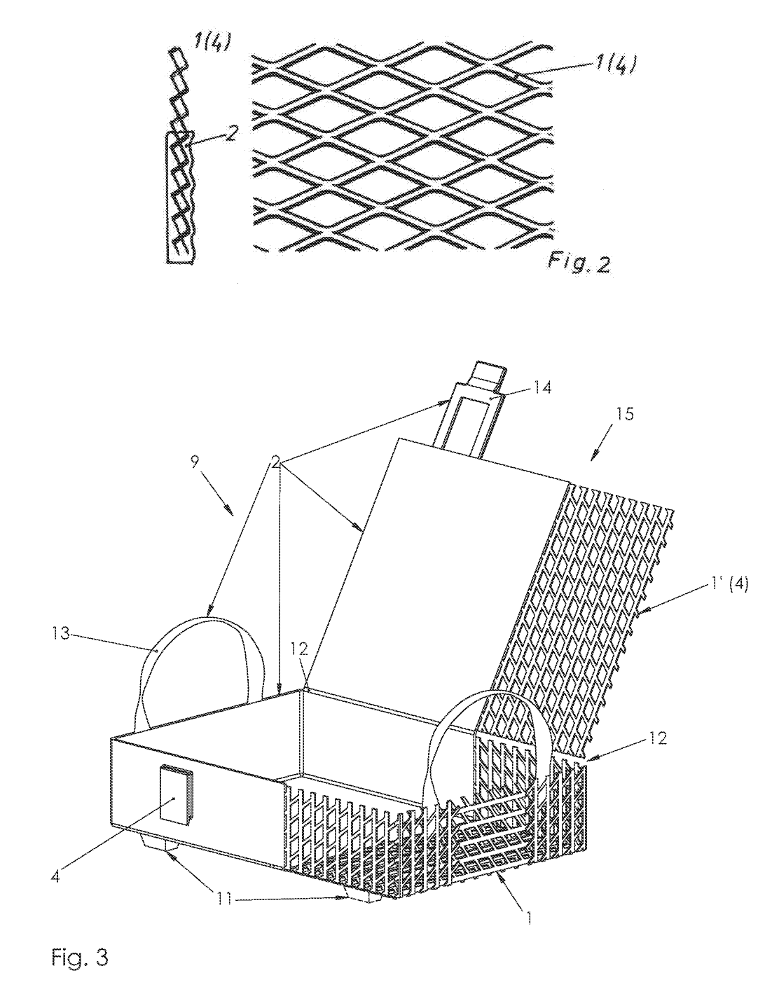

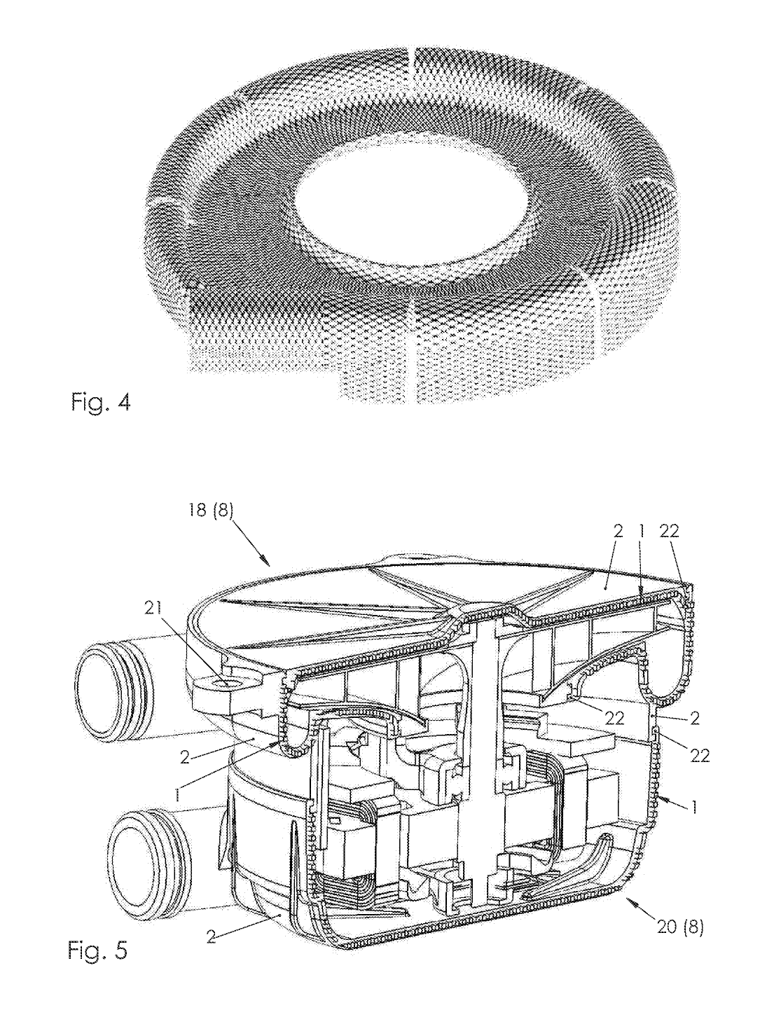

The reticular support grid 1 can also be braided, welded or glued, to achieve the necessary shape and strength. FIG. 3 shows a non-embedded part of the bent support grid 1 as part of a transport box. FIG. 4 shows the optionally composed support grid 1 of expanded metal for the volute of a blower, see also FIG. 5. In some cases it is sufficient to insert overlapping reticular parts (support grid 1) into the die cast mould. For example, parts of rib mesh 4 and/or made from wire netting 5 can be inserted. A sufficient overlap of these parts which are cast around and through which the embedding stuff 2 penetrates, guarantees a good cohesion of the hybrid structure 3. Further, the overlap can help for a higher local rigidity.

These support grid 1 and the other parts can be fixed one to another when placed in a die casting mould, so that their mutual position does not change under the influence of the injection pressure of the flowing embedding stuff 2. This pre-fixing can take place for example by interlocking, bending, secured with rivets, brazing, gluing or other methods that are compatible with the subsequent processing. The support grid 1 and the other parts which are inserted into a die mould (for example, nuts, electrical parts), can have suitable protrusions or spacers to provide that the proper position is maintained during the encapsulation (e.g. in the middle of the wall thickness of a housing 8).

Suggestions on how to realize more complex parts of the hybrid structure 3 can be found in the know-how of the art insert or outsert molding technique. The thermal expansion behavior of the housing 8 is given solely by the support grids 1. Since the support grid 1 is completely embedded in the soft embedding stuff 2, this first do not have to be finished. The elimination of surface treatment, deburring, etc. reduces production costs so that the support grid 1 is inexpensive. Common, inexpensive materials are suitable for the support grid 1. Sometimes it may be necessary to cover the support grid 1 with adhesion promoters (for example by immersion), which ensures good adhesion to the embedding stuff 2. Large parts will require large support grids preferably made of rib mesh. Special forms of metal netting are necessary when using endless strips, which must be stiff in the transverse direction and flexible in the longitudinal direction, so that they can be properly wound up. In the longitudinal direction (warp), take thin, flexible steel cables or wires, similar for example to the cables for the toothed belts. In the transverse direction (weft threads), take full, stiffer steel wires or when an intentional flexibility in both directions is required, also flexible steel cables. That way, for example, rolled state sound abating curtains made with such support grid 1 (flexible wire netting5), can be handled comfortably.

The Embedding Stuff 2

may consist of viscoelastic, sound-absorbing materials in particular, mainly rubber-like elastomers that would normally be used for seals, diaphragms, dampers, etc., whereby such functions are now performed by suitable formations in the case of a complex device. The terms “viscoelastic, sound absorbing” can be widely interpreted, because most substances have such properties, or get them by mixing or combination. With the special design of anti drumming foil 7 the embedding stuff 2 can be formed by other very different materials, such as further specified in the description. The preferred materials for the embedding stuff 2 include rubber, thermoplastic elastomers, silicone rubber, as well as soft polyurethane and foams based on these materials.

However, depending on the application one can use some mineral substances hold together by a binder, as far as they are economically advantageous. Depending on the specific conditions, the embedding stuff 2 can be applied by injection molding, casting, pressing, or injected as a liquid, or to be introduced with or without vulcanization in the die. The properties of the embedding stuff 2 are thus determined by the purpose of the hybrid structure 3, with a special focus on the sound absorption and thermal and chemical compatibility with the surrounding media. The embedding stuff 2 can also be applied in layers.

State of the art materials as aqueous synthetic resin dispersions, polyurethane ester foam, to polymer mineral mixtures etc. can also be taken for the embedding stuff 2. For most cases soft materials with a hardness of up to 80° Shore A are used as embedding stuff 2. Soft plastics such as PVC or soft ABS, polyurethane or even polyethylene may come into use. The properties (and the costs) of the embedding stuff 2 can be adjusted by adding suitable additives such as metal powder, minerals, short fibers, rubber pellets, rubber powder, carbon black, etc. Thus, density, strength or the body-borne noise barrier properties or anti-corrosion properties (for the support grid 1) of the embedding stuff 2 can be improved for example if a support grid 1 is made of steel and a mixture of zinc powder for the embedding stuff 2 are used. The embedding stuff 2 may also be in a liquid state, that is for instance a latex, and can be applied by dipping.

Production.

The usual injection molding or pressing processes in a mold is suitable to realize this invention for precision parts.

The parts of the support grid 1 as well as other components (such as nuts, but also other mechanical, pneumatic or electrical items) can be placed in the die for the purpose of embedding.

If the manufacturing process is carried out by pressing, a larger amount of the embedding stuff 2 (not vulcanized), is inserted in the plastic state into the press mould. The cavities of these press moulds form the “negative” of the objects to be realized. Everything is compressed (with heating), according to the specific technology of the materials. The hybrid structure 3 can also be formed with simpler shapes, in particular for large parts or “endless” bands, by dipping the support grid 1 in a rubber or elastomeric solution (latex, respectively the embedding stuff 2 in the liquid state). To perform this, the support grid 1 must be designed so that the gaps or holes are small enough to be adequately filled by the liquid embedding stuff 2. This way, after the pulling out of the support grid from the solution, a smooth skin covers it, that is vulcanized on the specific formulation. This procedure can also be repeated several times, even with different compositions before you get the desired property of the finished embedding stuff 2. Likewise, splattering can be used in order to build the embedding stuff 2; it can be combined with other methods if appropriate. For larger or thicker pieces out of rib mesh 4 is also possible to fill the interstices with a cheaper embedding stuff 2. The so formed hybrid structure 3 can be covered up on one or both sides with thin, environmentally resistant or decorative layers as an integrating part of a compo embedding stuff 2. The embedding stuff 2 can be applied not only here continuously with rollers. In this way, for example, slim and lightweight acoustical partitions or fences can be manufactured. In panels of rib mesh 4 or wire netting 5 the gaps are filled by dipping, brushing or troweling with an embedding stuff 2 applied in liquid or paste-like state. In such cases, this embedding stuff 2 can also contain recycled rubber.

Main Applications.

The main applications of the invention are transport boxes, housings for blower motors, fans or drive units, in particular the motor housing in vacuum cleaner motors, where formations as membranes for example may include pressure sensors, in acoustic enclosures, acoustic panels, sound insulation walls or curtains, boxes for speakers, absorber plates for hi-fi, etc.

Transport Boxes.

FIG. 3 illustrates an implementation of the invention as a transport box 9, which includes support grids 1, 1′. The support grid 1 here consists of a base plate which is bent at the corners and overlap (the main supporting structure) and of the lid with the support grid 1′. The embedding stuff 2 is here represented by the white area. The support grid 1 here consists of a piece of rib mesh 4 or a wire netting 5. The support grid 1′ of the lid 15 can have a higher elasticity, so that it can bend in order to better hold the contents, if necessary. On one longitudinal side between the support grids 1, 1′, a layer only of rubber can remain, which acts like a hinge 12. The lid 15 of the housing can be held by the in the closed position. The pull straps 14 uses the elastic properties of the embedding stuff 2 and emerge in the manufacturing process in the die. In order to see the support grid 1, 1 about ⅓ from the right side of the embedding stuff 2 is not shown. Other details such as the outwardly formed bumpers 11, the handles 13 and the strings 14 are built as protrusions from the uniform thickness of the embedding stuff 2. The handles 13 may be provided with a reinforcement consisting of a flexible fabric or fibers, ensuring the tensile strength of these handles after embedding. By appropriate shaping of the box and the lid, the tightness of the transport box can be achieved. If such a transport box falls down, it will not break like most of the common ones, but will absorb the shock caused by a possible partial deformation of the housing as a “crumple zone”. To ensure even better protection, a foam layer can be placed in the interior of the resulting transport box before the filling the embedding stuff 2. The support grid 1 and the foam placed inside the die can be encased around together with embedding stuff 2. A cut through the floor and outer walls of the finished box would show the following material layers (listed from bottom to top) show: embedding stuff 2, steeped support grid 1 with embedding stuff 2, foam, embedding stuff 2. An elastomer foam can be used as suitable for the layer. Loudspeaker boxes can be structured similar to this transport box, for which the acoustic properties can be considerably adjusted and improved.

Vehicle Structures.

According to the teachings of this invention, hybrid structures 3 may be formed for various panels or interior parts of vehicles, which are usually made of sheet metal and plastic. This is advantageous for large parts that should have sound absorbing properties, such as the separation between the engine compartment and passenger compartment, the dashboard and door panels. The big load-bearing structures (including their fixation to the chassis) will still remain out of sheet metal, but with corresponding voids, which are filled with the embedding stuff 2 (especially where a good feel, noise suppression or the protection of passengers in the event of accident are necessary). The large, flat areas of metal sheet are only modified as a support grid 1 through perforations or stretching as a rib mesh. Other details could be, as usual, covered with plastics.

On the dashboard, where the instruments or the air outlets of air conditioning are placed, these parts can be mounted using rubber surrounding areas. These rubber pieces are formed when filling the openings of the sheet (here as a supporting grid 1) with embedding stuff 2. The devices mounted here are thus fixed and sealed with a vibration damping effect and can retreat, if a certain force is exceeded in order to protect the passengers.

Sound Insulation Panels.

You can create sound insulation panels as a standalone product out of rib mesh 4 or wire netting 5 by filling the gaps by dipping, spraying, brushing with the embedding stuff 2 which is applied in liquid or paste-like state, described under “Production”. These noise reducing panels (hybrid structures 3) can be cut, bent or provided with a frame and so on. Acoustical partitions, fences or doors can be manufactured therefrom. In such cases, recycled rubber can be used as the base for the embedding stuff 2. For thinner, large noise reducing panels it may be advantageous if the surface thereof is structured in intervals of centimeters to tens of centimeters with small domes and appears flat only as a whole. This can reduce their resonance behavior. These methods described here can be applied also to cabinets, not only to insulate the noise of electric apparatus which arise within these cabinets; the establishment of several such cabinets in a room prevents that noise coming from outside will be reflected. The same applies to covers for noisy machinery, construction machinery, housings for pneumatic hammers.

Soundproof Curtains.

With a roll-up support grid 1 of special wire netting 5, with warp yarns made of flexible material, as shown in “support grid 1”, you can build easily transportable, even translucent soundproof curtains. Also in this case, the wire netting 5 can be longitudinally and transversely flexible if needed. The flexible wire netting 5 is embedded in a suitable filling material, which can be also translucent (e.g. silicone rubber, polyurethane, PVC soft).

Blowers.

FIG. 5 shows the assembly drawing of a high speed blower (e.g. for vacuum cleaners). The housing cover 18, the scroll housing 19 (see. FIG. 4) and the motor cover 20 (bottom) are subdivisions of the housing 8, which are designed as hybrid structures 3. These portions are created by embedding a support grid 1 of deep drawn rib mesh 4 (this gives the necessary strength of the parts) in an embedding stuff 2 with the aid of suitable die moulds. Here, these parts of a comparable size have a quasi-constant thickness of 2 to 4 mm and margin fixture shapings as clip connections 22 for the sealing assembly. These are elastic, impermeable, sound-deadening snap connections on the fitting periphery with the other adjacent components. The mounting grommet 21 is formed completely as a thicker protrusion of the embedding stuff 2, which is resilient and also prevents for example, that any residual vibration of the blower would be pass-by on a chassis from the sheet metal. Other functional details, such as passages for electrical conductors, aerodynamic profiles, pressure sensors, pressure relief valves, pressure relief flaps, profiles for the purpose of deflecting a flow etc. may be shaped out from the embedding stuff 2. These formations can be performed with known properties as known from the prior art, but with respect of the teachings of this invention. This type of housings can be combined with other hybrid structures 3 as well as with other parts, as known from the usual prior art.

Rotors for Blowers.

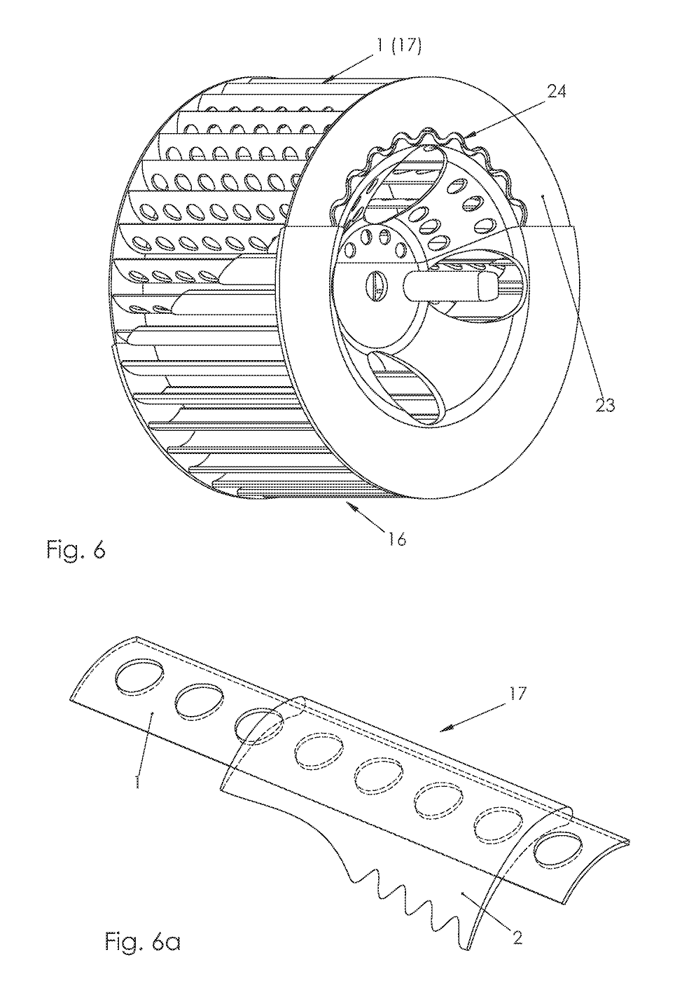

Another application of the invention is found in impellers 10 (or propeller) for fans, pumps and blowers. A significant reduction in the noise level according to the teaching of the invention is possible with the impellers 10 having annularly arranged metallic blades 17, which have a structure similar to that of the support grid 1, s. FIG. 6. These blades are annularly mounted on a drum circumference, which is driven by a hub 23 of the motor shaft. These blades 17 are encased by a sound-deadening embedding stuff 2. These blades 17 (see details, FIG. 6a) produce less noise than the conventional blades made of plastic or metal with straight trailing edges. Both, the noise which arises by their own vibration, as well as the noise which originates from the vibration of the motor shaft can be absorbed here.

The wrapping means of soft, elastic embedding stuff 2 allows (because of better elasticity of the rubber-like material) to build much finer, more elaborate aerodynamic profiles. Air leading structures can be produced that mimic the rear part of the wing of a bird. It is known that aerodynamic and noise emission characteristics of such structures from the nature have not been achieved technically yet. The elastic properties of the rubber (in contrast to the stiff plastics) allow that such complicated structures are realized with relatively simple dies. This design can be used in almost all axial and radial blowers.

FIG. 6 shows for example an impeller, which is present in almost all the cars for the interior air conditioning system. According to the prior art, this impeller is mainly made from a material which must have one hand a good mechanical strength and good thermal stability, as well as on the other hand it has to prevent noise and vibration. In technical terms, these properties are often contradictory. The impeller according to FIG. 6 solves these problems by being constructed as a hybrid structure 3.

Similar as in living creatures, a combination of a soft cover on a hard skeleton gives also to an impeller properties that a single material alone cannot have.

The support grid 1 provides the mechanical strength of the component also at higher temperatures, while the embedding stuff 2 completes the aerodynamic shape and suppresses vibration and noise generation. The support grid 1 is preferably made from aluminum and may consist of one or more parts. It makes sense that the hub 23 which directs the torque of the motor shaft to blade drum 16 is build in such way that no direct metallic contact (acoustic bridge) exists from the motor shaft to the blades 17. For this purpose, the hub 23 has a wave-shaped discontinuity 24, which is bridged only by the embedding stuff 2, so that the torque is transmitted solely by the continuity of the embedding stuff 2. This soft structure gives the fan self-balancing characteristics, that make the usual balancing process redundant. The wings of an impeller can become clogged over time with dust and debris. In a design with a rubber layer which performs minor bends at each speed and load change, this helps to wipe away these deposits by itself. A speed-dependent bending of the (appropriately designed) edges of the blades 17, consisting only of the embedding stuff 2 can also cause that you can obtain deliberate, speed-dependent profile shifts, which leads to the improvement of the aerodynamic characteristics at certain speeds. This would also lead in relatively simple radial impellers to properties that match those of an impeller with adjustable pitch angle.

Anti Drumming Foils, General Constitution.

A special application of the described hybrid structures 3 is the anti drumming foil 7 which serves as a coating for thin parts which are prone to vibrations (especially sheet metal parts), this foil being for example used as an adhesive foil.

This anti drumming foil is intended to replace advantageously the widely used “heavy layers”, which usually consist of bituminous mixtures, or the sandwich plates (two metal sheets, with a visco-elastic adhesive in between).

The top of the anti drumming foil 7 can be provided with a fibrous coating, like a flock 27, a pile 28 (here a bouclé, s. FIG. 1e, f) or a fleece, which does not reflect incident sounds, or to be decorative, or for better haptic effect.

The preferred application for the anti drumming foil 7 are motor vehicle chassis, (for example, noise deadening of the doors, headliners, engine compartment, trunk), home appliances (washing machine, sink, fridge) air ducts, engine covers.

The simplest anti drumming foil 7 (1a, FIG. 2) consists of a wire netting 5 that forms the support grid 1 which is traversed by a embedding stuff 2 which has adhesive properties, or is coated on one or both sides by an adhesive layer 25, 25′. The anti drumming foil 7 is thus a hybrid structure 3 with specific dimensions and characteristics, which corresponds to a slightly thicker duct tape as a structure, however, is based on a wire netting 5, whose gaps are filled with the embedding stuff 2. The wire netting 5 and the embedding stuff 2 form here a discontinuous structure with micro cells (the voids of the wire netting 5). The anti drumming foil 7 can be marketed as a standalone product. If it is adhesive on both sides, the anti drumming foil 7 may be also used as double-sided adhesive tape, or it can be covered with decorative layers afterwards. The anti drumming foil 7 is much thinner and lighter than the aforementioned “heavy layers” of bitumen and is closer to the dimensions of the sandwich metal sheet, it is however lighter, has a better effect and can be attached subsequently to something. Compared to common, subsequently glued thin constraint layers, the anti drumming foil 7 has, due to its netting structure, a better spatial formability and a better stiffness parallel to the sheet carrier 6, thus a better effect as a constraining layer in that direction. The finished anti drumming foil 7 may be supplied, optionally after volatilization of a solvent in the product ready form of sheets or rolls, kept optionally apart by release layers (silicone paper). The release layer may remain unilaterally as a covering layer in double-sided adhesive anti drumming foils 7. The typical thickness of an anti drumming foil 7 (without a pile) is between 0.3-1.5 mm.

Definitions:

Wire netting 5 defines here a flat structure which is arranged in the manner of a constraining layer in a small distance from the sheet carrier 6. As the sheet carrier 6 makes while vibrating microscopic movements, the wire netting 5 counteracts this movement as is being bond to the embedding stuff 2. The rigid wire netting 5 thus distributes the arising of the vibratory forces as good as possible in the visco-elastic embedding stuff 2, which leads to the decay of the vibration. The wire netting 5 can also be a rib mesh (4, s. FIG. 2), a knitted wire or non-woven metal filaments. The anti drumming foil 7 can also be built as a double metal fabric tape, however, with a relatively large-meshed wire cloth as a constraining layer, which is woven together with a second metal fabric with embedding stuff 2 as explained further below. For thin sheet carrier 6 thinner, finely woven wire netting 5 are suitable. For thicker sheet carriers 6 and larger areas a thicker wire netting 5 will accordingly be used. The material of the wire netting 5, from aluminum to stainless steel should be adjusted regarding particularly the thermal expansion coefficient and the compatibility with regard to the properties of the sheet carrier 6. Both round wires as well as flat wires can be used for the wire netting 5. For the correct action of the anti drumming foil 7 is necessary that the wire netting 5 has a certain, small distance (0.02 to 0.3 mm) to the sheet carrier 6. However, this does not mean that portions of the wire netting 5 cannot be (laser-) welded or glued for example, at the door or the headliner of a car at few points, some centimeters distant from each other for purposes of pre-fixation. In this case the embedding stuff 2 is subsequently introduced as a kind of primer with visco-elastic properties through the meshes of the wire netting 5. So the anti drumming foil 7 is completed there and sticks to the sheet carrier 6. This primer can consist of a mixture of a polymer with an inexpensive mineral filling, with a hardness which ranges up to this of the common primer and however acts anti drumming because of the microscopic damping between the components. A special variant of the wire netting 5 is the coated wire netting 5′. (FIG. 1d) Here, the wire which is used is provided prior or after weaving (see FIG. 1c, cross section of a wire netting 5, but uncoated) with a visco-elastic coating 26 and the whole is embedded by the deposition of the embedding stuff 2, so that this visco-elasticity leads to a vibration damping compared to the wire netting (5).

The visco-elastic coating 26 is mainly subjected to mechanical micro deformations resulting from the transmission of the vibrations of the sheet carrier 6 and transmitted via the connecting embedding stuff 2′ against the resistance of the wire netting 5. The absorption of the vibration energy occurs largely in the visco-elastic coating 26, the rest of the connecting embedding stuff 2′ can therefore be freely designed (more economic). The advantage of this method is that the wire netting 5 (including coating 26) is completely embedded in a hard embedding stuff 2′, so between the embedding stuff 2 and the sheet carrier 6 the soft adhesive layer is not longer visible or distracting. Therefore, this variant is suitable to be mounted also on the outer surface of a vehicle, where it is hidden under a coating. The wire netting 5 is defined by the nature of the metallic wire, mesh size, wire diameter and the ratio warp/weft thread. As a guideline for the quality of the wire netting 5, a mesh size of approximately 6-40 meshes per inch with wire diameter of about 0.12-0.5 mm can be assumed. The embedding stuff 2 can be in each shape, more or less elastic or solid, as a homogeneous or heterogeneous material that passes the wire netting 5 through and is attached by bonding or adhesion to the sheet carrier 6, so that the micro-movements from between the sheet 6 and wire cloth 5 and the undesirable vibrations are suppressed as a result. Depending on the application, environmental conditions and technology, the embedding stuff 2 can be considered together or separately with the adhesive layer 25. In the simplest case the embedding stuff 2 is composed of a visco-elastic glue and thus simultaneously acts as an adhesive layer 25. As examples, hot melt adhesives are (suitable for use at lower temperatures) or Acrylpolymere-adhesive, suitable for higher temperatures. The adhesive layer on top of the anti drumming foil 7 can act as an adhesive for a noise abating flocking 27, see FIG. 1e) or for fastening further decorative or functional layers, the bottom layer is used to bond it on the sheet carrier 6.

The embedding stuff 2 can consist of several layers, with the same or different compositions depending on the application. One can use typical adhesives, which are usually used for adhesive tapes, on the basis of rubber, other synthetic resins, or even bitumen. Fillers, for example, mineral substances or metal powder may be admixed in the embedding stuff 2; in this case, it is similar to a thick paint layer or to a primer.

The embedding stuff 2 can be woven as a thread in a loom along with the metal wires that gives the wire netting 5, so that a double weave arises. For this, added threads out of visco-elastic material (e.g. polyamide or polyester) as warp or weft threads, will be sandwiched in between the metal wires. The result, with or without subsequent treatment (smoothing, impregnation, adhesive layer) is a finished anti drumming foil 7. The embedding stuff 2 is characterized by its affixing and composition (which may also be heterogeneous). The adhesive layer 25 is an intermediate layer between the embedding stuff 2 and the sheet carrier 6 resulting out the embedding stuff 2 and/or an adhesive layer disposed on the other side of the embedding stuff 2.

Production of the Anti Drumming Foil 7.

The prefabricated wire netting 5 can be penetrated in an appropriate stage by dipping, spraying or other methods with the embedding stuff 2 and will be then cured. All the common types of curing up to the reactive curing are possible. The adhesive layer 25 can be added later, for example “from a reel” as a double-sided adhesive tape. The accompanying silicone paper (release layer) remains then left until the bond on the sheet carrier 6 as a protective film of the adhesive layer 25. In this case, the embedding stuff 2 can also be quite hard, and thereby contribute to the rigidity of the mating wire netting 5-embedding stuff 2. The sound absorbing properties are partly due to the viscoelastic adhesive layer 25. The embedding stuff 2 can also be an inexpensive, temperature-resistant mineral dispersion with a suitable binder. The mentioned variant as double thread fabric also offers the option to realise a side (top) of the double fabric—anti drumming foil 7 with a pile, which is sound and heat insulating, optionally also so, that it avoids condensation. One can use modified weaving techniques, as adjusted from the carpet or fabric manufacture knowledge. The pile (s. FIG. 1f, here a bouclé) is using a third, the polar thread. The anti drumming foil 7 here as a three-dimensional tissue with a sound absorbing surface is thus made in a single weaving. In order to finish the anti drumming foil 7 with a pile, an adhesive layer 25 will be added on the other side against the pile 28. Such an anti drumming foil with appropriate aspect and feel can be directly used for the headliner of a car or as a floor covering.

If one uses the wire netting 5′ with the viscoelastic coating 26 (shown in bold black) so the embedding stuff 2′, which keeps together the other components can be rather hard, with no special viscoelastic properties. In this case, the coated wire netting 5′ can be attached before by self-adhesion to the sheet carrier 6. Then, the embedding stuff 2 is formed is made of suitable material (for example a primer). A (soft) adhesive layer to the sheet carrier 6 (which would be visible as a cutting line) is no longer available, so the coated wire netting 5 can be completely embedded. The embedding stuff 2 can have properties from hard viscoelastic until sticky. The adhesive layer 25 may be, depending on the application from very thin (50 μm or more) and should fit in terms of temperature and chemical resistance the application; all the softer (viscoelastic) adhesives are eligible for it. The adhesive layer 25 may accept any suitable form (double-sided tape, spray adhesive, hot melt adhesive, two component glue, etc.

The anti drumming foil 7, can be used both for original equipment (e.g. automotive industry), or can be subsequently applied from individual users (single use). For serial applications, the most appropriate options can be selected from a wide range of materials.

Single use: for the single use, self-adhesive anti drumming foils 7 can be chosen mainly from a few standard types.

In order to keep the number of variants small, several anti drumming foils 7 of similar or different type can be bonded on top of others to improve for example the noise deadening of certain frequencies.

For serial applications, it is important to select production technologies as inexpensive as possible, which often leads to that the anti drumming foil 7 is composed on the spot. In the manufacture of a car door for example, it may be useful to use metal sheets which are already provided with spot-welded wire netting 5, which was attached even before processing (compression shaping, etc.) of the door sheets. With appropriate treatment and painting, even the outside of a door, which is located under the window can be provided with a anti drumming foil 7. The formation of the anti drumming foil 7 is then accomplished by the filling of the wire netting 5 with the embedding stuff 2 in the manner of a primer. The externally placed anti drumming foil 7 prevents that the sheet carrier 6 (chassis) is excited there by noise or impacts (hail, rain) from the outside. As outer layer the anti drumming foil 7 can be designed to be decorative and can be replaced after damage by hail, stone chip or wear (wheel house, car bottom). The anti drumming foil 7 placed towards the car cabin serve as carpet or headliner if provided with a pile 28.

### Advantages

The fabric structure permits that the anti drumming foil 7 adapts better to curved surfaces. It withstands the temperature levels which occur at painting/drying processes, for example, and can be easily recycled. The sound anti drumming foil 7 is inexpensive to produce even for temperatures above 250° C., stewing at higher temperatures no odors, is paintable and can be stuck on.

1. Noise deadening hybrid structure comprising a support grid (1) of rigid supports having a discontinuous grid-like design and a viscoelastic embedding stuff (2) surrounding the support grid (1).

2. Hybrid structure according to the claim 1, characterized in that the support grid (1) is made of metallic wires that are woven, braided, welded or formed as a non-woven fleece.

3. Hybrid structure according to the claim 1, characterized in that the support grid (1) is made of a metal sheet which is punched, deep-drawn or worked out as a rib mesh (4).

4. Hybrid structure according to the claim 1, characterized in that the support grid (1) is made of a non-metallic material.

5. Hybrid structure according to the claim 1, characterized in that the embedding stuff (2) has an elastomer composition which can be sprayed, vulcanized, or can be applied by dipping, squeegee, or rollers to the support grid (1).

6. Hybrid structure according to the claim 1 wherein the embedding stuff (2) is characterized in that in its composition at least one of minerals, mineral dispersions with appropriate binders, short fibers, rubber granulate, rubber powder, carbon black, or metal powder are added in order to adjust the density, strength or viscoelastic properties of the embedding stuff (2).

7. Hybrid structure according to the claim 1, characterized in that the embedding stuff (2) is an adhesive with viscoelastic properties.

8. Hybrid structure according to the claim 1, characterized in that the support grid (1) and the embedding stuff (2) are assembled in a die by injection moulding, casting or pressing, so to form the hybrid structure (3) with or without vulcanization.

9. Hybrid structure according to the claim 8, characterized in that at least two overlapping parts of the support grid (1) are attached to each other by wrapping and flowing through the embedding stuff (2).

10. Hybrid structure according to the claim 8, characterized in that the support grid (1) is formed by a pre-fixing in the die prior to being recast with the embedding stuff (2).

11. Hybrid structure according to claim 9, characterized in that it comprises the support grid (1) as base which is curved as a box, the hybrid structure further comprising a lid (15) out of second support grid (1′) material, said parts being included in an embedding stuff (2) and that a straight side of the adjacent zones of the support grids (1,1′) are formed as a film hinge (12), which is shaped from the embedding stuff (2), to form a transport box.

12. Hybrid structure according to claim 11, characterized in that it includes also further functional components at least one of handles (13), bumpers (11), straps (14), which are built by the shaping of the embedding stuff (2).

13. Hybrid structure according to claim 10 wherein the hybrid structure is a housing for noise producing devices, characterized in that these housings (8 <18,19,20>), which are supported by a framework of support grids (1, <4, 5>), have additional functionality without supplementary components by presenting particular shapings derivated by moulding the embedding stuff (2) in a die, to form at least one of sealing clip connections (22), elastic mounting grommets (21) shaft seals, passages for electrical components, sealing assemblies, aerodynamic profiles, pressure sensors, pressure relief valves, and flaps for the deflection of a flow.

14. Hybrid structure according to the claim 8 wherein the hybrid structure is a rotor for fans and pumps, characterized in that the rotor consists of a purposeful designed blade drum (16) with blades (17) and a hub (23) which form a metal support grid (1) being designed symmetrically and without balance error and that on this aero- or hydrodynamic profiles with noise deadening properties are shaped out of the embedding stuff (2).

15. Hybrid structure according to the claim 14, characterized in that the hub (23) which transmits the motion from the motor shaft to the blade drum (16) has a discontinuity (24), so that there is no direct metallic connection from the motor shaft to the blades (17).

16. Hybrid structure according to claim 15, characterized in that the edges of the blades (17), which consist only of the embedding stuff (2) perform profile shifts depending of the rotation-speed.

17. Hybrid structure according to the claim 8, characterized in that the support grid (1) is formed from a sheet metal skeleton with box-like deep-drawn areas that are built in the manner of a rib mesh (4) or of a perforated plate at the places which will be covered by the embedding stuff (2), so they are designed to form cavities for the rattle-free storage of various items.

18. Hybrid structure according to the claim 1, characterized in that it is built of sheets of support grid (1) such as rib mesh (4) or wire netting (5) with sufficient mechanical strength, which are provided as a factory standard with a coating of embedding stuff (2).

19. Hybrid structure according to the claim 1 characterized in that its surface is textured with domes.

20. Hybrid structure according to the claim 1, characterized in that it consists of a longitudinally flexible support grid (1) made of special wire netting (5) with warp threads of flexible material or out of a rib mesh (4) which are covered with an embedding stuff (2), this applied singly or in layers which can be from opaque to translucent or transparent.

21. Hybrid structure according to the claim 1 wherein the hybrid structure is an anti drumming foil (7) to be applied on sheet carriers (6), the anti drumming foil (7) characterized in that the anti drumming foil (7) consists of wire netting (5) or rib mesh (4) which are penetrated by an embedding stuff (2) which fixes these (5, 4) on sheet carriers (6).

22. Hybrid structure according to the claim 21, wherein the anti drumming foil (7) is characterized in that these are delivered as strips or sheets which are self-adhesive on the one or on both sides.

23. Hybrid structure according to the claim 21, wherein the anti drumming foil (7) is characterized in that they are produced in situ where they are applied to reduce noise, wherein after pre-fixing of a support grid (1), made of wire netting (5) or rib mesh (4) on a sheet carrier (6), whereby this first (1,5,4) is penetrated up to the sheet carrier (6) by an embedding stuff (2) and remains finally attached to this sheet carrier (6).

24. Hybrid structure according to the claim 21 wherein the anti drumming foil (7) is characterized in that the embedding stuff (2) in each design variant is elastic or solid, homogeneous or heterogeneous bonds the wire netting (5) to the sheet carrier (6).

25. 7 Hybrid structure according to the claim 24, wherein the anti drumming foil (7) is characterized in that the wire netting (5) is provided with a viscoelastic coating (26) which contributes by viscoelasticity to a damping of vibrations between the wire netting (5) and the embedding stuff (2).

26. Hybrid structure according to the claim 21, wherein the anti drumming foil (7) is characterized in that the wire netting (5) and the embedding stuff (2) combine together as a double fabric, by co-weaving metal wire interposed in_between with threads from viscoelastic material, which create the anti drumming foil 7, which can be subsequently treated.

27. Hybrid structure according to the claim 21, characterized in that the surface of the embedding stuff (2) is provided by suitable methods for individual cases with a sound-absorbing fibrous coating (27, 28) formed by flocking (27) or a pile (28) or by the application of a fleece.
